(19) United States
(12) Patent Application Publication
(10) Pub. No.: US 2014/0120776 A1
(43) Pub. Date: May 1, 2014

(54) POWER SUPPLY DEVICE AND ELECTRONIC DEVICE EMPLOYING THE SAME

(71) Applicant: HON HAI PRECISION INDUSTRY CO., LTD., New Taipei (TW)

(72) Inventors: CHAN-KUEI HSU, New Taipei (TW); ZHENG-HENG SUN, New Taipei (TW); TE-CHUNG KUAN, New Taipei (TW)

(73) Assignee: HON HAI PRECISION INDUSTRY CO., LTD., New Taipei (TW)

(21) Appl. No.: 14/059,456

(22) Filed: Oct. 22, 2013

(30) Foreign Application Priority Data
Oct. 26, 2012 (TW) 101139853

(51) Int. Cl. H01R 12/72

(52) U.S. Cl. CPC H01R 12/72
USPC 439/629

(57) ABSTRACT

An electronic device includes a power supply device supplying power for an electronic element. The power supply device includes a shell defining a receiving space. A first circuit board includes a main body received in the receiving space and a connection portion extending from the main body. A first sub-connector includes a number of first connection pins arranged on the connection portion and a number of second connections pins arranged on an opposite side of the connection portion. A connector is arranged between the second connection pins and an electronic element. The connector transmits power to the electronic element.

### BACKGROUND

1. Technical Field

The present disclosure relates to a power supply device and an electronic device using the power supply device.

2. Description of Related Art

Power supply devices that are used to supply power for electronic devices may require a number of cables, and the electronic device may require a number of cables to receive power. The cables of the power supply device connect to the cables of the electronic device via a connector. However, the cables of the power supply device and the cables of the connector occupy a large amount of space.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of an electronic device employing a power supply device to supply power via a connector, according to an exemplary embodiment.

FIG. 2 is an exploded view of the power supply device of FIG. 1.

FIG. 3 is a schematic diagram of the power supply device having cables of different lengths to supply power for different electronic elements.

### DETAILED DESCRIPTION

Reference will be made to the drawings to describe various embodiments.

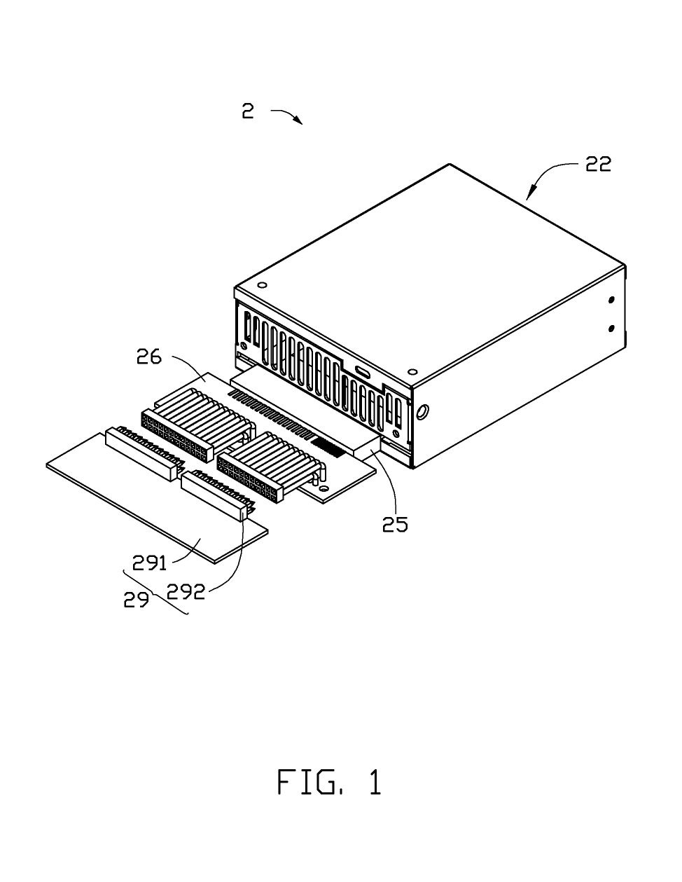

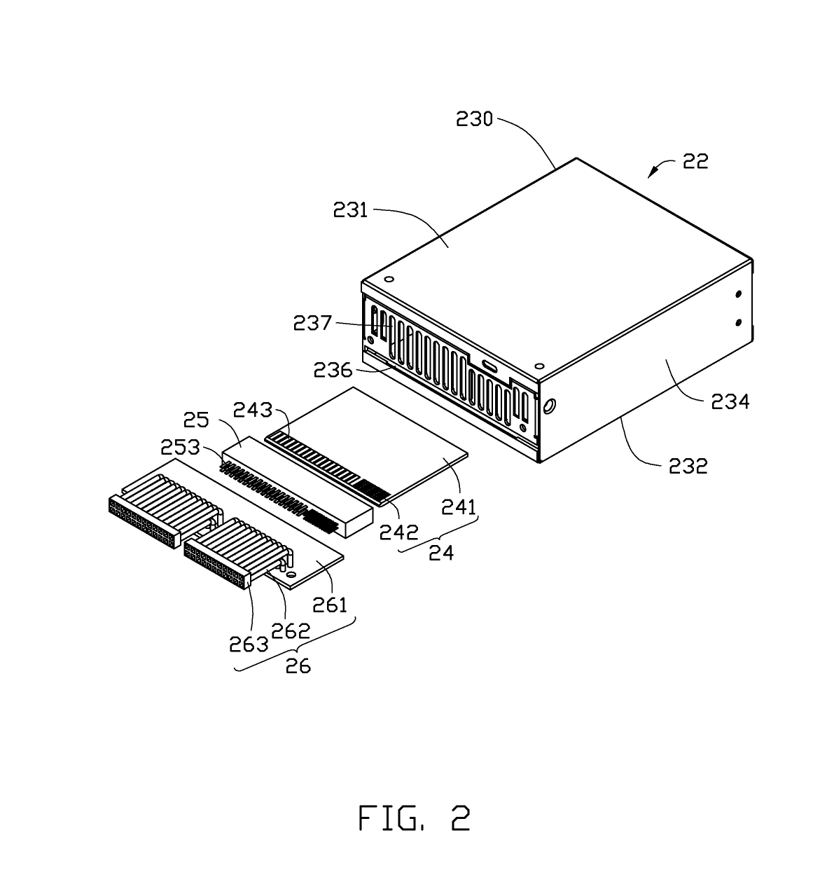

FIG. 1 and FIG. 2 show an electronic device 2 including a power supply device 22, a connector 26, and an electrical element 29. The power supply device 22 supplies power for the electrical element 29 via the connector 26. The power supply device 22 includes a shell 230, a first circuit board 24, and a first sub-connector 25. The shell 230 accommodates other components (not shown) of the power supply device 22 therein. The first circuit board 24 includes a main body 241 and a connection portion 242 extending from a side of the main body 241. The shell 230 receives the main body 241. The connection portion 242 is connected to the main body 241 and protrudes out of the shell 230 from a side surface of the shell 230. The first sub-connector 25 is connected between the connection portion 242 and the connector 26. The connector 26 transmits power to the electronic element 29.

In the embodiment, the shell 230 is substantially cuboid, but the disclosure is not limited thereto The shell 230 includes a top plate 231, a bottom plate 232, and four side plates 234 connected between the top plate 231 and the bottom plate 232. The top plate 231, the bottom plate 232, and the four side plates 234 cooperatively define a receiving space for receiving the components of the power supply device 22. One of the four side plates 234 defines an opening 236 and a plurality of heat-dissipating holes 237. The main body 241 is received in the receiving space. The connection portion 242 protrudes out of a side plate 234 via the opening 236.

The first circuit board 24 includes a plurality of first connection pins 243, such as golden fingers arranged on the connection portion 242, configured to plug into the first sub-connector 25.

In the embodiment, the first sub-connector 25 is a card edge connector. One side of the first sub-connector 25 defines a receiving groove (not shown) to receive the plurality of first connection pins 243. The first sub-connector 25 includes a plurality of second connection pins 253 that are arranged on another side of the first sub-connector 25 opposite to the receiving groove. The second connection pins 253 are arranged in two parallel rows. The second connection pins 253 are soldered to the connector 26.

The connector 26 includes a second circuit board 261, a plurality of cables 262, and a connection port 263. The second connection pins 253 are soldered to the second circuit 261 to establish an electrical connection between the second circuit board 261 and the first sub-connector 25. One end of each cable 262 is soldered to the second circuit board 261. The other end of each cable 262 is connected to the connection port 263.

The electrical element 29 includes a third circuit board 291 and a second sub-connector 292. The second sub-connector 292 corresponds to the connection port 263 and is arranged on the third circuit board 291.

In use, the first connection pins 243 are received in the first sub-connector 25, the second connection pins 253 are soldered to the second circuit board 261, and the connection port 263 is connected to the second sub-connector 292. Thus, the power supply device 22 supplies power for the electrical element 29.

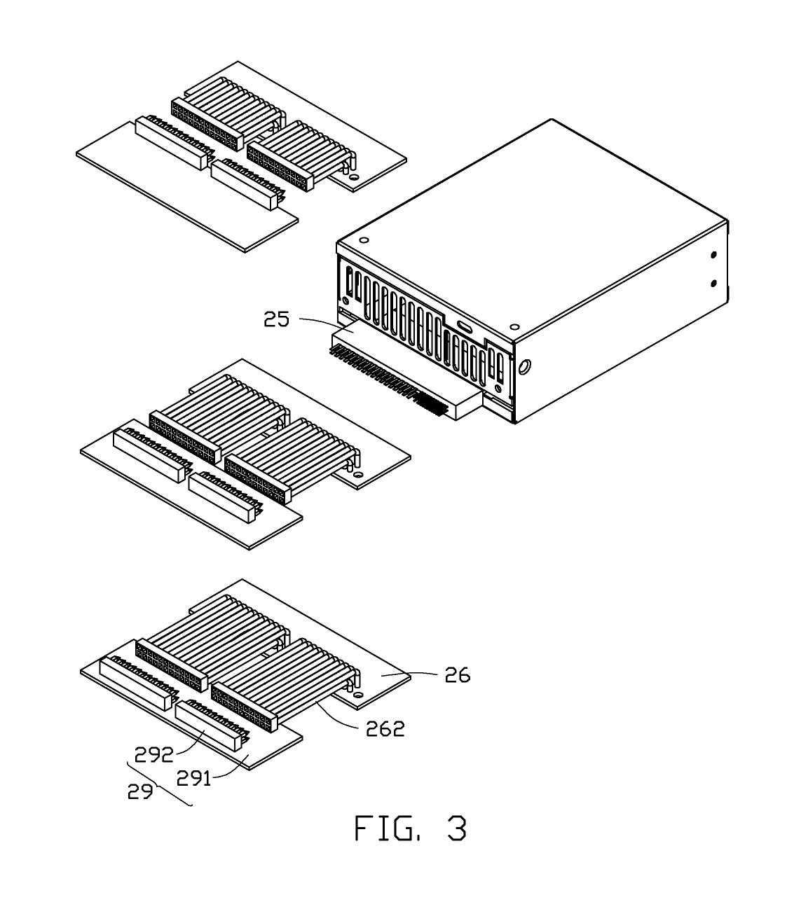

In FIG. 3, the power supply device 22 is capable of supplying power for different electronic elements 29 by only changing a length of the cables 262. For example, when the electronic element 29 is arranged near the connector 26, the length of the cables 262 is short, and when the electronic element 29 is arranged farther away from the connector 26, the length of the cables 262 is long.

In summary, the power supply device 22 supplies power for the electronic device 2 via the first circuit board 24, the first sub-connector 25, and the connector 26. Thus, the power supply device 22 occupies a smaller amount of space. Further, the power supply device 22 is capable of supplying power to different electronic elements 29 by only changing a length of the cables 262.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A power supply device, comprising:
a shell having a receiving space;
a first circuit board having a main body received in the receiving space and a connection portion extending from a side of the main body;
a first sub-connector, one side of the first sub-connector defining a groove configured to receive a plurality of first connection pins arranged on the connection portion, a plurality of second connection pins arranged on another side of the first sub-connector; and
a connector being arranged between the second connection pins and an electronic element to transmit power to the electronic element.

2. The power supply device of claim 1, wherein the first connection pins are configured to plug into the first sub-connector, and the second connection pins are soldered to the connector.

3. The power supply device of claim 1, wherein the connector comprises a second circuit board, a plurality of cables, and a connection port, the second circuit board is electrically connected to the second connection pins of the first sub-connector, the cables are connected between the second circuit board and the connection port, and the connection port is connected to the electronic element.

4. The power supply device of claim 3, wherein a first end of each cable is soldered to the second circuit board, and a second end of each cable is connected to the connection port.

5. The power supply device of claim 1, wherein the shell comprises a top plate, a bottom plate, and four side plates to cooperatively define the receiving space.

6. The power supply device of claim 5, wherein one of the side plates defines an opening from where the connection portion protrudes out of the side plate.

7. The power supply device of claim 6, wherein the side plate which defines the opening further comprises a plurality of heat-dissipating holes.

8. An electronic device, comprising a power supply device supplying power for an electronic element, the power supply device comprising:
a shell having a receiving space;
a first circuit board having a main body received in the receiving space and a connection portion extending from a side of the main body;
a first sub-connector, one side of the first sub-connector defining a groove configured to receive a plurality of first connection pins arranged on the connection portion, a plurality of second connection pins being arranged on another side of the first sub-connector; and
a connector being arranged between the second connection pins and an electronic element to transmit power to the electronic element.

9. The electronic device of claim 8, wherein the first connection pins are configured to plug into the first sub-connector, and the second connection pins are soldered to the connector.

10. The electronic device of claim 8, wherein the connector comprises a second circuit board, a plurality of cables, and a connection port, the second circuit board is electrically connected to the second connection pins of the first sub-connector, the cables are connected between the second circuit board and the connection port, and the connection port is connected to the electronic element.

11. The electronic device of claim 10, wherein a first end of each cable is soldered to the second circuit board, and a second end of each cable is connected to the connection port.

12. The electronic device of claim 8, wherein the shell comprises a top plate, a bottom plate, and four side plates to coorperatively define the receiving space.

13. The electronic device of claim 12, wherein one of the side plates defines an opening from where the connection portion protrudes out of the side plate.

14. The electronic device of claim 13, wherein the side plate further defines a plurality of heat-dissipating holes.

15. The electronic device of claim 10, wherein the side plate which defines the opening further comprises a plurality of heat-dissipating holes.

16. The electronic device of claim 15, wherein when the second sub-connector is arranged near the connector, the length of the cables is short, and when the second sub-connector is arranged far away from the connector, the length of the cables is long.
